(19) United States
(12) Patent Application Publication
(10) Pub. No.: US 2016/0307160 A1
(43) Pub. Date: Oct. 20, 2016

(54) SYSTEM FOR ARRANGING PROFILES OF JOB SEEKERS IN RESPONSE TO A SEARCH QUERY

(71) Applicant: ABHIMAN TECHNOLOGIES PRIVATE LIMITED, BANGALORE (IN)

(72) Inventors: Abhijit KHASNIS, BANGALORE (IN); Manjunath Sannappa TALWAR, BANGALORE (IN)

(73) Assignee: ABHIMAN TECHNOLOGIES PRIVATE LIMITED, BANGALORE (IN)

(21) Appl. No.: 14/883,644

(22) Filed: Oct. 15, 2015

(30) Foreign Application Priority Data
Apr. 20, 2015 (IN) 2021/CHE/2015

(51) Int. Cl. G06Q 10/10; G06F 17/30

(52) U.S. Cl. CPC G06Q 10/1053; G06F 17/30867; G06F 17/30528; G06F 17/3053

(57) ABSTRACT

A system for arranging or ranking profiles of job seekers in response to a search query is provided. The system includes one or more processors configured to determine likelihood of changing job at least by those job seekers whose profile match a search criteria. The likelihood of changing job is determined based at least on activities carried out the job seekers within a job portal, activities carried out the job seekers on one or more digital platforms outside the job portal, and correlation between time elapsed, corresponding to each of the job seekers, since changing the last job held by the job seeker and tendency of changing job. The processor is further configured to influence arrangement or ranking of the profiles by at least considering the likelihood of changing job by each of the job seekers whose profile match the search criteria.

### BACKGROUND

Unless otherwise indicated herein, the materials described in this section are not prior art to the claims in this application and are not admitted to be prior art by inclusion in

### FIELD

The disclosed subject matter in general relates to job portals and more particularly, but not exclusively, the subject matter relates to arranging or ranking profiles of job seekers in response to a search query.

### DISCUSSION OF RELATED FIELD

Job portals are one of the sources through which employers identify job seekers to fill employment opportunities that are available in their organizations. Job portals typically provide search interface for bath employers and job seekers.

The search interface provided to employers allow them to specify search parameters, such as, education qualification, skill set, experience and location of job seekers, among others. The job portal may return profiles of job seekers that match the search parameters, in response to the search. In a search result page(s), the profiles may be arranged in a descending order of their match to the search parameters.

On several occasions, some of the job seekers whose profiles may be ranked higher in the result, owing to their match with the search parameters, may not even be actively looking out for a job change. Ranking of such dormant/inactive profiles higher than those who are actively seeking job change may lead to unsatisfactory user experience. The instant drawback is partially addressed by considering, while ranking profiles, how recently a profile has been uploaded to the job portal and how often or recently a job seeker has updated his/her profile or accessed his/her account in the job portal. Such considerations may have partially addressed the instant drawback. However, there may exist, a possibility that a job seeker's profile may be inactive in a particular job portal, while the job seeker actively pursues job change using other means.

In light of the foregoing discussion there is a need for an improved technique for arranging or ranking profiles of job seekers in response to a search query.

### SUMMARY

An embodiment provides a system for arranging or ranking profiles of job seekers in response to a search query. The system includes one or more processors configured to determine relative likelihood of changing job at least by those job seekers whose profile match a search criteria. The likelihood of changing job is determined based at least on activities carried out by the job seekers within a job portal, activities carried out the job seekers on one or more digital platforms outside the job portal, and correlation between time elapsed, corresponding to each of the job seekers, since changing the last job held by the job seeker and tendency of changing job. The processor is further configured to influence arrangement or ranking of the profiles by at least considering the relative likelihood of changing job by each of the job seekers whose profile match the search criteria.

### BRIEF DESCRIPTION OF DRAWINGS

Embodiments are illustrated by way of example and not limitation in the Figures of the accompanying drawings, in which like references indicate similar elements and in which:

FIG. 1 is an exemplary architecture of an exemplary system 100 for arranging or ranking profiles of job seekers in response to a search query, in accordance with an embodiment;

FIG. 2 is an exemplary block diagram of the exemplary system 100 for arranging or ranking profiles of job seekers in response to a search query, in accordance with an embodiment:

FIG. 3 is an exemplary fact sheet illustrating information that may be present corresponding to a job seeker within the system 100, in accordance with an embodiment; and

FIG. 4 is a flow chart of an exemplary method of determining relative activity score of job seekers for arranging or ranking profiles of job seekers in response to a search query, in accordance with an embodiment.

### DETAILED DESCRIPTION

In an embodiment, a job portal system may store profiles of several job seekers. Employers or job providers or recruiters or searchers (who may be referred to as “employer” or “employers” or “job provider” or “job providers”) may carry out a search in the job portal by submitting search parameters. The job portal while returning profiles of job seekers in response to the search may consider the relative likelihood of changing job at least by those job seekers whose profiles match a search criteria (search string) while ranking or arranging the profiles. The arrangement of the profiles may be influenced by the relative likelihood of changing job by those job seekers. As an example, if two profiles equally match the search parameters, such as education qualification, skill set and experience, a profile of a job seeker who is more likely to change job may be ranked higher than the one who is relatively less likely to change job. The likelihood of changing job by a job seeker may be determined based on activities carried out by the job seeker within the job portal, activities carried out by the job seeker on one or more digital platforms outside the job portal, and correlation between time elapsed since changing the last job held by the job seeker and tendency of changing job.

The following detailed description includes references to the accompanying drawings, which form a part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments. The embodiments can be combined, other embodiments can be utilized, or structural, logical and electrical changes can be made without departing from the scope of what is claimed. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The disclosed subject matter in general relates to job portal and more particularly, but not exclusively, the subject matter relates to arranging profiles of job seekers in response to a search query.

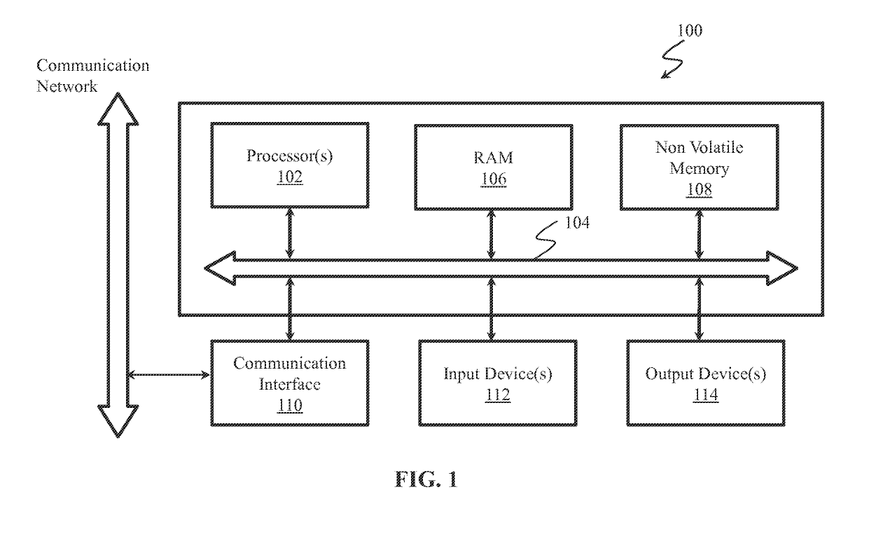

Referring to the figures, more particularly to FIG. 1, an exemplary architecture of an exemplary system 100 is provided for arranging or ranking profiles of job seekers in response to a search query. The system 100 may be one or more server and may include one or more processors 102, a bus system 104, a random access memory 106, a disk drive or non-volatile memory 108, a communication interface 110, input device(s) 112 and output device(s) 114.

The processor 102 may be any hardware which returns output by accepting signals, such as electrical signals as input. In one embodiment, processors 102 may include one or more computer processing units (CPUs). The processor(s) 102 may communicate with a number of peripheral devices via the bus subsystem 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

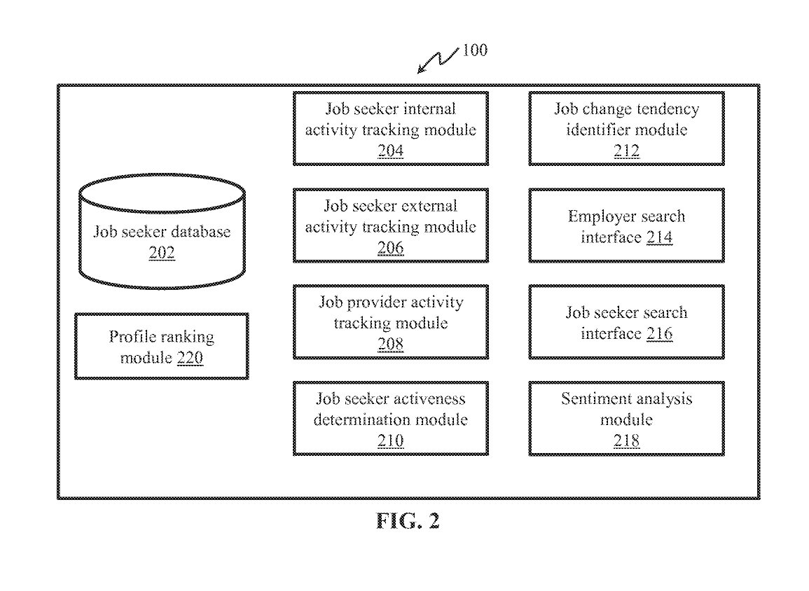

Referring to FIG. 2 as well, the system 100 may be hosted or supported or executed by the above discussed architecture, in an embodiment. The system 100 may include a job seeker database 202, a job seeker internal activity tracking module 204, a job seeker external activity tracking module 206, a job provider activity tracking module 208, a job seeker activeness determination module 210, a job change tendency identifier module 212, an employer search interface 214, a job seeker search interface 216 (used by job seekers for searching), a sentiment analysis module 218 and profile ranking module 220.

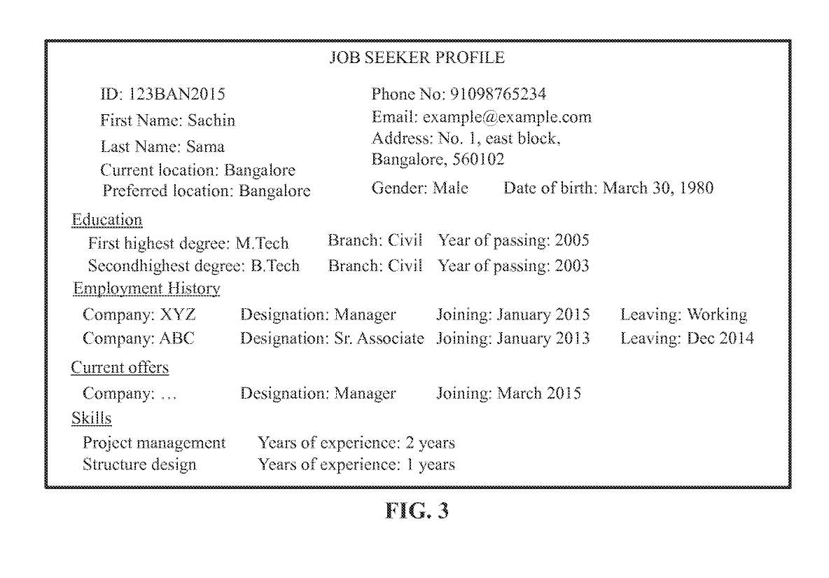

In an embodiment, the job seeker database 202 may store profiles or information corresponding to job seekers. Referring to FIG. 3, the information corresponding to a job seeker may include job seeker ID, name, age, gender, current location, preferred location(s), education qualification information, skill information, experience information, previous employment information, current employment information, and proposed date of joining a. newly offered job, among others. It may be noted that some of the fields may be mandatory and some may be optional. Further, some of the values may be derived from the information submitted by the job seeker or obtained from a source other than the job seeker.

In an embodiment, the job seeker internal activity tracking module 204 may be configured to track and/or record activities of job seekers in the job portal/system 100. The activities carried out in the system 100 by a job seeker may include, but not limited to, creating a profile, updating the profile, accessing the profile, conducting search, checking job openings, applying for job(s), responding to queries, sharing job openings, saving the job openings for future use and responding to communication sent through the system 100, among others. It may be noted that one or more of the above discussed activities may be considered to determine the activity level of a job seeker within the system 100. Further, weightage may be assigned to the activities/parameters that may be considered to determine the activity level of the job seeker within the system 100.

In an embodiment, job seeker external activity tracking module 206 may be configured to track activities of the job seekers on one or more digital platforms outside the job portal/system 100. The one or more digital platforms may include social/professional networking portal(s), other job portal(s), search engine website(s), skill showcasing platform(s) and forums, among others.

As an example, the activities of the job seeker on one or more digital platforms outside the system 100 may be tracked using cookies present in the job seeker's device(s). The job seeker external activity tracking module 206 may access the job seeker's browsing history, which may include history of visiting other job portals, searching for jobs in other job portals or search engines, applying for jobs in other job portals, updating resume in other job portals and taking online test on other websites, among others. Hence, even if the job seeker is relatively inactive on the system 100, he may still be actively looking out for jobs using other digital means, which is identified by the job seeker external activity tracking module 206.

As a further example, the job seeker may have provided access to track some of his activities on a professional networking platform to the system 100. The job seeker external activity tracking module 206 may track the activities of the job seeker on such a platform. Activities such as, but not limited to, updating profile, adding contacts, taking part in discussions and seeking or receiving recommendations, may be considered as activities carried out by an active job seeker.

It may be noted that one or more of the above discussed activities may be considered to determine the activity level of a job seeker on one or more digital platforms outside the job portal/system 100. Further, weightage may be assigned to the activities/parameters that may be considered to determine the activity level of the job seeker on one or more digital platforms outside the job portal/system 100.

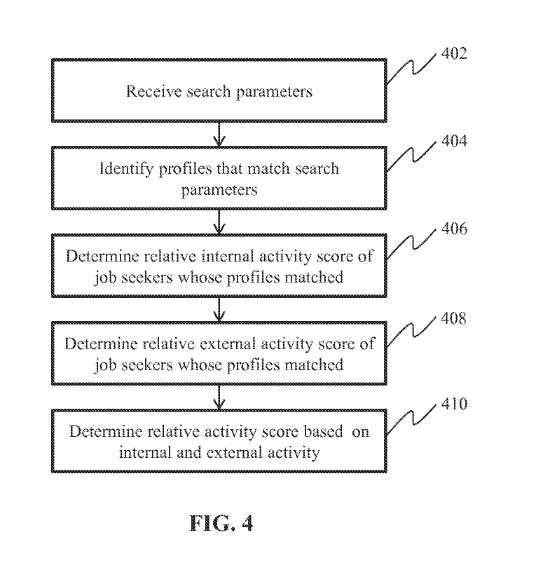

In an embodiment, the job seeker activeness determination module 210 may be configured to determine relative activity score of job seekers whose profiles match search parameters that may be entered by an employer/searcher/recruiter. Referring to FIG. 4, the system 100 receives search parameters through the employer search interface 214, at step 402. The processor 102 may query the job seeker database 202 and identify those profiles that match the search parameters, at step 404. The job seeker activeness determination module 210, at step 406, may determine relative internal activity score of job seekers whose profiles matched the search parameters. “Relative internal activity score” may mean relative score indicating activeness of a job seeker with respect to other job seekers whose profiles matched the search parameters. The job seeker internal activity tracking module 204 may provide information required to determine the relative internal activity score. Further, as discussed earlier, the score may depend on the parameters considered and the weightage assigned to the considered parameters. Likewise, the job seeker activeness determination module 210, at step 408, may determine relative external activity score of job seekers whose profiles matched the search parameters. “Relative external activity score” may mean relative score indicating activeness of a job seeker with respect to other job seekers whose profiles matched the search parameters. The job seeker external activity tracking module 206 may provide information required to determine the relative external activity score. Further, as discussed earlier, the score may depend on the parameters considered and the weightage assigned to the considered parameters. Further, at step 410, the job seeker activeness determination module 210 may determine relative activity score based on internal and external activity score. It may be noted that the relative activity score may depend on the weightage assigned to the internal activity score and the external activity score.

In an embodiment, the job change tendency identifier module 212 may be configured to correlate, for each of plurality of job seekers (as an example, whose profiles have matched search parameters), time elapsed since changing the last job held by each of the job seekers and tendency of changing job by each of the job seekers. The correlation may yield a score indicating relative propensity of each of the job seekers to change his/her job.

The job change tendency identifier module 212 may determine the time elapsed since changing the last job held by a job seeker using data submitted by the job seeker.

In an embodiment, the job change tendency identifier module 212 may determine the tendency of a job seeker of changing his/her current job based on the data (user history) submitted by the job seeker. As an example, the profile of the job seeker may include dates of joining and leaving one or more previous jobs. Such dates may indicate a trend, which as an example may indicate that the job seeker switches jobs in approximately two years.

In an embodiment, the job change tendency identifier module 212 may determine the tendency of a job seeker of changing his/her current job based on tendency of changing job by other job seekers having similar or comparable profiles.

In an embodiment, the job change tendency identifier module 212 may determine the tendency of a job seeker of changing his/her current job based on tendency of changing job in a domain to which the job seeker belongs.

In an embodiment, one or more of the above three parameters are considered to determine the tendency of changing job. Further, weightage may be assigned to each of the parameters that are considered.

In an embodiment, only when the tendency cannot be determined using previous history of the job seeker, will the job change tendency identifier module 212 consider the tendency of changing job by other job seekers having similar or comparable profiles. Further, only when the tendency cannot be determined using tendency of changing job by other job seekers having similar or comparable profiles, will the job change tendency identifier module 212 consider tendency of changing job in a domain to which the job seeker belongs.

In an embodiment, the sentiment analysis module 218 is configured to determine the sentiment of companies in which the job seekers are currently employed. The sentiment analysis module 218 may process the data within the system 100 to determine trends of companies. As an example, if there is a surge in the number of candidates who have uploaded their profiles from the same company, the sentiment analysis module 218 may anticipate that the company may be laying off employees or employees from that company are interested in switching jobs. As an example, if two profiles have the same score, then a job seeker who is working in a company corresponding to which there is a surge in profile uploads may be ranked higher than the one who is working in a company corresponding to which no such activity is witnessed.

In an embodiment, the sentiment analysis module, in addition to the above technique or exclusively, may crawl through web pages (which are independent of the job portal), such as news, business and press release, among other websites, to determine the sentiment of the company or job seekers from that company, A news article from a company “A” which has made a press release that they will be laying off 50% of their workforce may be crawled by the sentiment analysis module 218, and may recognise that job seekers from this company may be actively looking to switch jobs; consequently, profiles from such companies may be provided a higher score.

In an embodiment, the profile ranking module 220 may consider various parameters to rank/arrange the profiles in response to a search query. The parameters may include, but not limited to, extent to which the profiles match with the search parameters, relative activity scores based on internal and external activity and scores indicating relative propensity of each of the job seekers to change his/her job. Each of the parameters may be assigned weightage, and accordingly the profiles may be arranged or ranked or scored. The profile ranking module 220 may consider an additional parameters corresponding to job providers' activities with respect to the profiles of the job seekers.

In an embodiment, the profile ranking module 220 may consider proposed date of joining a new job by a job seeker to determine the ranking of the job seekers profile. As an example, if two profiles have the same score, then a job seeker who has a date of reporting to a new job in the near future may be ranked higher than the one who's joining date in further ahead or who does not have any new job offers.

In an embodiment, the system 100 further includes a self learning module. The self learning module, based on the activities of searchers/employers/recruiters corresponding to the search results, may vary the weightage assigned to parameters, consider new parameters or seize considering some of the parameters.

It shall be noted that the processes described above is described as sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A recruitment system, wherein the system comprises:
at least one database; and
at least one server operatively coupled to the at least one database, wherein the server
comprises at least one recruitment processing application configured to:
receive notice period information corresponding to job seekers;
store the notice period information corresponding to profiles of the job seekers in the database; and
allow searching the profiles of job seekers based on notice period information.

2. The recruitment system according to claim 1, wherein the recruitment processing application is further configured to receive information from the job seekers corresponding to, one or more of, new job offer information, current information, past employment information, and personal and professional information.

3. The recruitment system according to claim 1, wherein the recruitment processing application is further configured to allow searching the profiles of job seekers based on, one or more of new job offer information, current employment information, past employment information, and personal and professional information.

4. The recruitment system according to claim 1, wherein the recruitment processing application is further configured to allow recruiters to save one or more search criteria for searching profiles of job seekers and filter profiles of job seeker matching the saved search criteria.

5. The recruitment system according to claim 1, wherein the recruitment processing application is further configured to enable job seekers to conceal their identity from recruiters, and reveal their identity to one or more recruiters upon authorization from the job seekers.

6. A method of recruitment, wherein the method comprises:
receiving notice period information corresponding to job seekers;
storing the notice period information corresponding to profiles of the job seekers in a database; and
allowing searching the profiles of job seekers based on notice period information.

7. The method of recruitment according to claim 6, further comprising receiving information from the job seekers corresponding to, one or more of, new job offer information, current employment information, past employment information, and personal and professional information.

8. The method of recruitment according to claim 6, further comprising allowing searching the profiles of job seekers based on, one or more of, new job offer information, current employment information, past employment information, and personal and professional information.

9. The method of recruitment according to claim 6, further comprising allowing recruiters to save one or more search criteria for searching profiles of job seekers and filtering profiles of job seeker matching the saved search criteria.

10. The method of recruitment according to claim 6, further comprising enabling job seekers to conceal their identity from recruiters, and revealing their identity to one or more recruiters upon authorization from the job seekers.
